(19) United States
(12) Patent Application Publication
(10) Pub. No.: US 2008/0264265 A1
(43) Pub. Date: Oct. 30, 2008

(54) Ice coffee maker

(76) Inventor: Yu-Yuan Lin, Tainan (TW)

Correspondence Address: Yu-Yuan LIN, P.O. Box 1032,, Tainan, 704, TW

(21) Appl. No.: 11/796,160

(22) Filed: Apr. 27, 2007

(51) Int. Cl. A47J 31/057

(52) U.S. Cl. 99/288

(57) ABSTRACT

An ice coffee maker includes an electric heating percolator and a coffee pot. The electric heating percolator heats and boils coffee, which flows in the coffee pot. The coffee pot consists of an outer container with an upper opening and a front spout, and an inner container cone-shaped with a hole and an upper disk rim provided with a front notch to face the spout of the outer container. An inner container lid sealingly closes on the opening of the inner container. An outer container lid closes the opening of the outer container. In using, ice cubes are placed in the inner container, with the inner container lid closing up the opening. Then the inner container is placed in the outer container, with the disk rim closing up the opening of the outer container, which is superposed with the opening of the inner container. Then the coffee pot is placed under the electric percolator, so hot coffee flows into the outer container through the space defined by the notches of the inner container and the outer container lid and by the spout of the outer container to let the coffee cool off quickly and become ice coffee.

### BACKGROUND OF THE INVENTION

1. Field of the Invention

This invention relates to an ice coffee maker, particularly to one able to quickly make ice coffee that can maintain the density and the original aroma of hot coffee.

2. Description of the Prior Art

A conventional coffee maker provided with an electric heating device for making coffee, as shown in FIG. 1, includes an electric heating percolator 1 and a coffee pot 2. The electric heating percolator 1 is provided with a water tank 10 having one side disposed with a material container 11 filled therein with powdered coffee and having its bottom fitted with an outgoing tube 12. Thus, when the water in the water tank 10 is boiled by the electric heating device, the boiling water will flow through the material container 11 and make coffee from the powdered coffee therein, and then the hot coffee will flow out through the outgoing tube 12 and get into the coffee pot 2 positioned at the lower side of the electric heating percolator 1. The coffee pot 2 is formed with an opening 20 aligned to the outgoing tube 12 for receiving the hot coffee flowing out through the outgoing tube 12. The coffee pot 2 is further assembled with a handle 21 to be held for moving the coffee pot 2.

However, the conventional coffee maker can only make hot coffee by means of the electric heating percolator 1. If a person wishes to drink ice coffee, the hot coffee made by the electric heating percolator 1, after cooling off, has to be placed in the cooling compartment of a refrigerator for quite a long time to convert it into ice coffee with rich aroma, thus taking too much time in making ice coffee. Another method of having the hot coffee cooling off quickly is to add ice cubes to the hot coffee; nevertheless, after the ice cubes are melted into ice water and mixed with the coffee, it will greatly dilute the density and the original aroma of the coffee.

### SUMMARY OF THE INVENTION

The objective of this invention is to offer an ice coffee maker able to quickly make ice coffee that can maintain the original density and aroma of hot coffee.

The ice coffee maker in the present invention includes an electric heating percolator and a coffee pot. The electric heating percolator is provided with a water tank having its upper side assembled with a material container deposited therein with powdered coffee and having its bottom fitted with an outgoing tube. The coffee pot positioned at the lower side of the electric heating percolator has one side of its upper opening formed with a spout aligned to the outgoing tube of the material container. The electric heating percolator has its electric heating device boiling the water in the water tank and quickly the boiling water will flow through the material container and make coffee from the powdered coffee therein and then the hot coffee will flow into the coffee pot through the outgoing tube. The coffee pot is composed of an outer container, an inner container, an inner container lid and an outer container lid.

The outer container has its topside bored with an opening having its front side formed with a spout for coffee to flow in and out therethrough.

The inner container shaped as an inverted cone has its topside provided with an opening and a disk rim around the opening. The disk rim has its front section cut with a notch corresponding to the spout of the outer container.

The inner container lid is to be covered on the opening of the inner container for sealing up the opening.

The outer container lid to be covered on the opening of the outer container has its front section cut with a notch to be correspondingly superposed on the notch of the inner container.

In using, firstly, the inner container is filled therein with lots of ice cubes and the inner container lid is tightly covered sealingly on the upper opening of the inner container. Next, the whole inner container is positioned in the interior of the outer container, letting the upper disk rim of the inner container seal up the opening of the outer container and having the notch of the inner container corresponding to the spout of the outer container. Subsequently, the outer container lid is covered on the opening of the outer container and pressed tightly to let the notch of the outer container lid superposed by the notch of the inner container correspondingly, and then the coffee pot is positioned at the lower side of the electric heating percolator. After the electric heating percolator has boiling water making coffee from the powdered coffee in the material container, the coffee will flow out through the outgoing tube to get into the outer container through the space defined by the two notches of the outer container lid and the inner container and by the spout of the outer container. At this time, the ice cubes in the inner container will function to lower the temperature of the coffee in the outer container and convert it into ice coffee.

Furthermore, said disk rim of said inner container is pivotally assembled thereon with a handle for lifting up said inner container.

### BRIEF DESCRIPTION OF DRAWINGS

This invention will be better understood by referring to the accompanying drawings, wherein:

FIG. 1 is a side view of a conventional coffee maker;

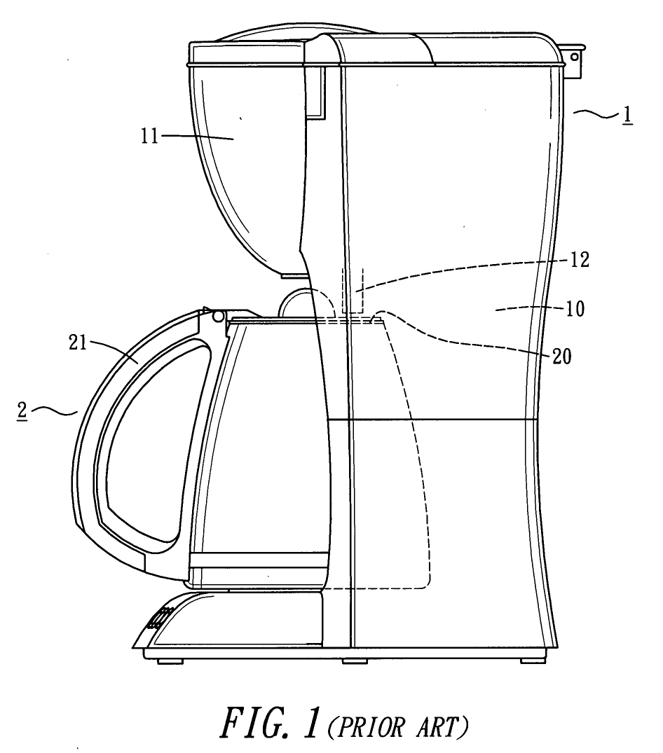

FIG. 2 is a side view of an ice coffee maker in the present invention;

FIG. 3 an exploded perspective view of the ice coffee maker in the present invention;

FIG. 4 is an exploded perspective view of a coffee pot in the present invention;

FIG. 5 is a partial combination view of the coffee pot in FIG. 4; and

FIG. 6 is a cross-sectional view of the coffee pot in a using condition in the present invention.

### DETAILED DESCRIPTION OF THE PREFERRED EMBODIMENT

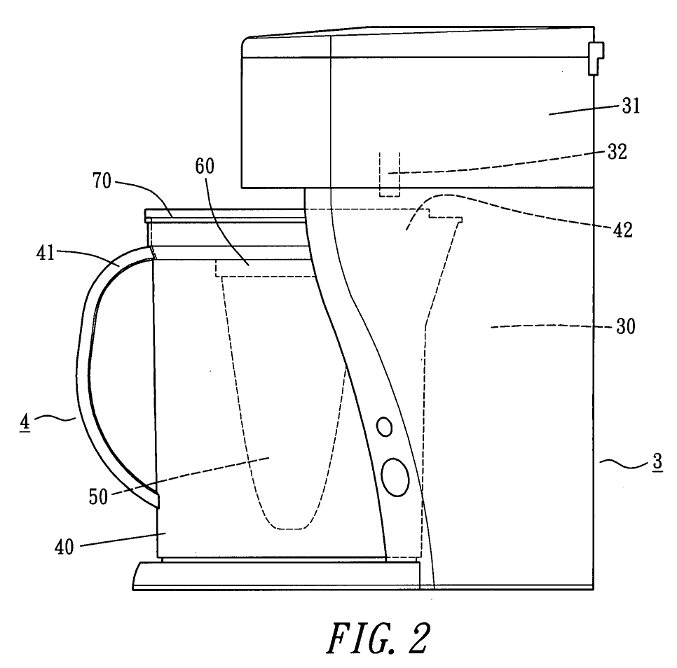

A preferred embodiment of an ice coffee maker in the present invention, as shown in FIG. 2, includes an electric heating percolator 3 and a coffee pot 4 combined together.

The electric heating percolator 3 is provided with a water tank 30 and a material container 31 positioned above the water tank 30 for depositing powdered coffee therein and having its bottom fitted with an outgoing tube 32 for the hot coffee made by the electric heating percolator 3 to flow out therethrough.

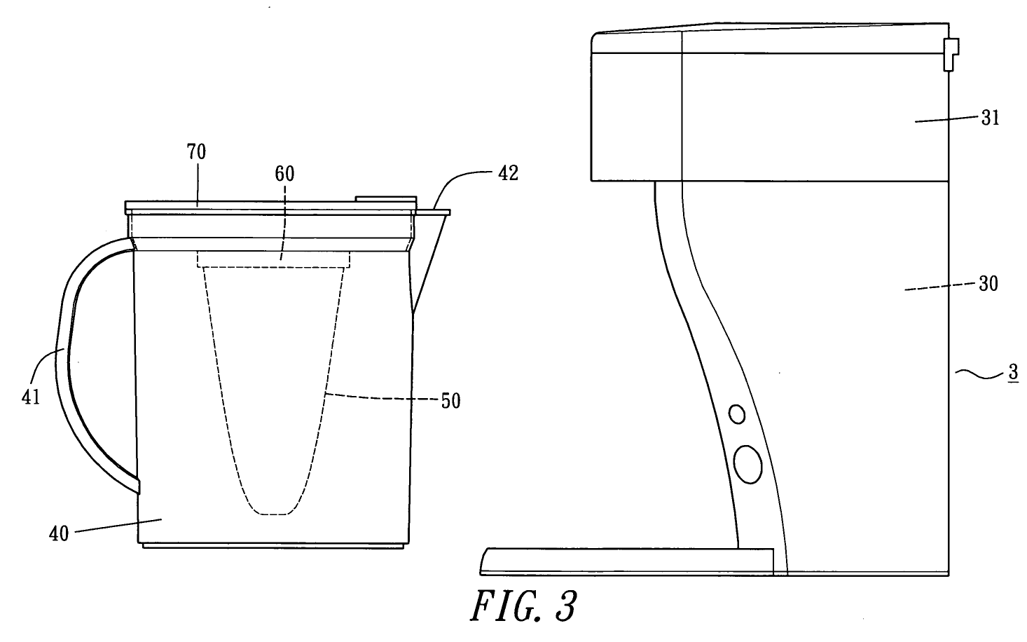

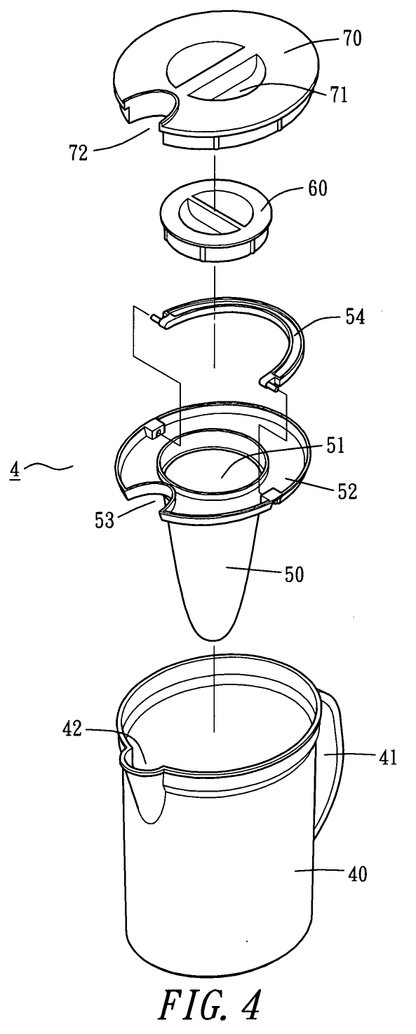

The coffee pot 4, as shown in FIGS. 3 and 4, is positioned at the lower side of the electric heating percolator 3, composed of an outer container 40, an inner container 50, an inner container lid 60 and an outer container lid 70.

The outer container 40 is provided with a handle 41 at one side and a spout 42 at the front side of its upper opening for receiving the coffee flowing out through the outgoing tube 32 and letting the coffee flow into the outer container 40.

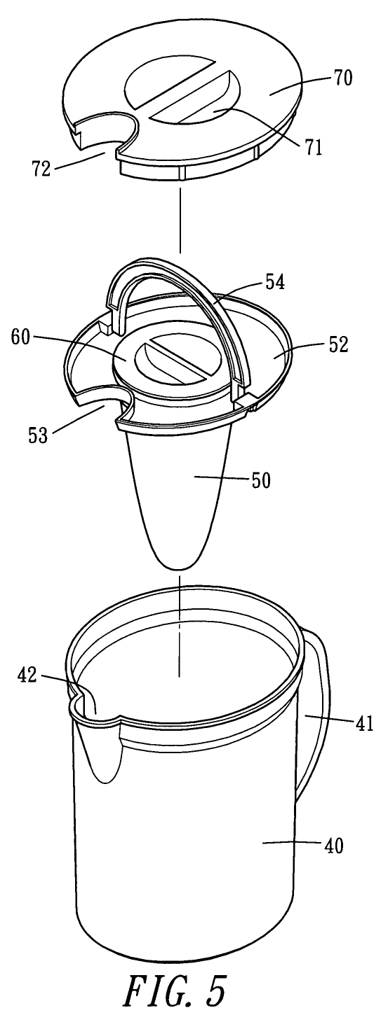

The inner container 50 shaped as an inverted cone has its topside provided with an opening 51 and a disk rim 52 around the opening 51. The disk rim 52 has its front section cut with a notch 53 corresponding to the spout 42 of the outer container 40 and its topside pivotally assembled with a handle 54, as shown in FIG. 5.

The inner container lid 60 is to be covered on the opening 51 of the inner container 50 for sealing up the opening 51, as shown in FIG. 5.

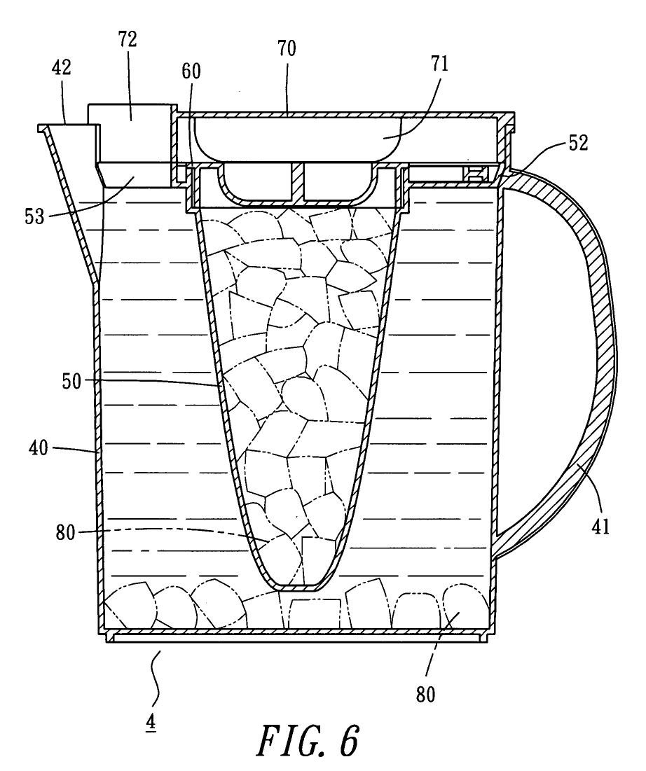

The outer container lid 70 is to be covered on the opening of the outer container 40, having its underside formed with a downward projection 71, as shown in FIG. 6. Thus, when the outer container lid 70 is closely covered on the outer container 40, the projection 71 under the outer container lid 70 can push against the inner container lid 60 for pressing the inner container lid 60 to closely seal up the opening 51 of the inner container 50. Further, the outer container lid 70 has its front section cut with a notch 72 matching with the notch 53 of the inner container 50 for mutual superposition.

In using, referring to FIGS. 5 and 6, firstly, the inner container 50 is filled with lots of ice cubes 80, and the outer container 40 could also be placed therein with a few ice cubes 80 under a condition of not diminishing the aroma of coffee. Next, the inner container lid 60 is tightly covered on the upper opening 51 of the inner container 50 to seal up the opening 51, and then the whole inner container 50 is placed in the interior of the outer container 40, letting the upper disk rim 52 of the inner container 50 closely rest on the edge of the opening of the outer container 40. Subsequently, the outer container lid 70 is covered on the upper opening of the outer container 40 and pressed tightly to let the projection 71 under the outer container lid 70 closely pressed on the inner container lid 60 for preventing ice water formed in the inner container 50 from leaking out after the ice cubes 80 in the inner container 50 are melted. At this time, a space is defined by the two mutually superposed notches 72 and 53 of the outer container lid 70 and the disk rim 52 of the inner container 50 and by the spout 42 of the outer container 40. Lastly, the coffee pot 4 is positioned at the lower side of the electric heating percolator 3. Thus, when the electric heating percolator 3 is electrically connected and reaches a certain temperature, the water in the water tank 30 will be boiled, and the boiling water will flow through the material container 31 and make coffee from the powdered coffee in the material container 31. Then, the hot coffee will flow out through the outgoing tube 32 and get into the outer container 40 through the space defined by the notches 72, 53 and the spout 42. Simultaneously the ice cubes 80 in the inner container 50 will function to quickly lower the temperature of the hot coffee to convert the hot coffee into ice coffee that can maintain the original aroma and density of the hot coffee. The ice coffee made by the ice coffee maker of this invention is much better in taste than the conventional ice coffee made by adding ice cubes to hot coffee for cooling off.

Further, since the portion between the inner container 50 and the outer container 40 is completely sealed up; therefore, even if the ice cubes 80 in the inner container 50 should melt into ice water and the outer container 40 should be slanted to one side, the ice water in the inner container 50 would not overflow out of the inner container 50 and get into the outer container 40. Furthermore, when the ice cubes 80 in the inner container 50 are melted into water but the water does not become cold enough, simply uncover the outer container lid 70 of the outer container 40 and hold the handle 54 of the inner container 50 to remove the inner container 50 out of the outer container 40. Afterward, uncover the inner container lid 60 to pour out the water in the inner container 50, and then put ice cubes in the inner container 50 anew and place the inner container 50 in the outer container 40, thus able to permanently keep the coffee cold and maintain the density and aroma of the coffee.

While the preferred embodiment of the invention has been described above, it will be recognized and understood that various modifications may be made therein and the appended claims are intended to cover all such modifications that may fall within the spirit and scope of the invention.

I claim:

1. An ice coffee maker comprising an electric heating percolator and a coffee pot, said electric heating percolator provided with a water tank having one side disposed with a material container for depositing powdered coffee therein, said material container having its bottom fitted with an outgoing tube, said coffee pot positioned at a lower side of said electric heating percolator, said coffee pot formed with a spout aligned to said outgoing tube, said electric heating percolator provided with an electric heating device for boiling the water in said water tank, said boiling water flowing through said material container and making coffee from said powdered coffee in said material container, said coffee flowing into said coffee pot through said outgoing tube, said coffee pot comprising:
an outer container having its topside bored with an opening, said outer container having its upper front side formed with a spout for coffee to flow in and flow out therethrough;
an inner container shaped as an inverted cone, said inner container having its topside bored with an opening and provided with a disk rim around said opening, said disk rim having its front section cut with a notch corresponding to said spout of said outer container, said inner container positioned in an interior of said outer container, said disk rim sealing up said opening of said outer container;
an inner container lid covered on said opening of said inner container for sealing said opening; and
an outer container lid covered on said opening of the outer container, said outer container lid having its front section cut with a notch matching with said notch of said inner container, said two notches of said outer container lid and said inner container able to be correspondingly superposed on each other.

2. The ice coffee maker as claimed in claim 1, wherein said disk rim of said inner container is pivotally assembled thereon with a handle for lifting up said inner container.
